(19) United States
(12) Patent Application Publication
(10) Pub. No.: US 2009/0031502 A1
(43) Pub. Date: Feb. 5, 2009

(54) Mattress and Method of Manufacturing the Same

(76) Inventors: William G. Berrcocal, Holly Springs, NC (US); John Earley, Northboro, MA (US)

Correspondence Address: KRIEGSMAN & KRIEGSMAN, 30 TURNPIKE ROAD, SUITE 9, SOUTHBOROUGH, MA, 01772, US

(21) Appl. No.: 11/667,947

(22) PCT Filed: Nov. 16, 2005
(86) PCT No.: PCT/US05/41494

§ 371 Date: May 14, 2008

Related U.S. Application Data
(60) Provisional application No. 60/628,219, filed on Nov. 16, 2004.

(51) Int. Cl. A47C 27/05; A47C 27/14; B68G 9/00; F16B 5/07

(52) U.S. Cl. 5/716; 29/91.1; 411/500

(57) ABSTRACT

A mattress includes a plurality of individual foam blocks which are secured together using one or more plastic fasteners to form a five-sided foam encasement. A spring unit is fittingly disposed within an interior cavity defined by the foam encasement. One or more top layers of foam rubber are mounted on the foam encasement over the spring unit and are secured thereto using additional plastic fasteners. An outer layer of quilted cotton material is sewn over the foam encasement and top layers of foam rubber to yield the finished one-piece mattress. As can be appreciated, the outer periphery of the mattress is defined by foam material, which is substantially rigid in its construction, rather than the spring unit, which is highly susceptible to warping. In this manner, the foam material serves to preserve the shape of the outer periphery of the mattress over time.

### BACKGROUND OF THE INVENTION

The present invention relates generally to the manufacture of mattresses.

Mattresses are well-known in the art and are commonly used alone or in combination with additional components to form a bed on which a person may rest and/or sleep. Many types of conventional mattresses comprise a spring unit to provide its user with a satisfactory level of support and comfort.

A mattress spring unit typically includes an upper frame and a lower frame which are spaced slightly apart and which are arranged in a substantially parallel configuration. Each frame (also commonly referred to as a wire box) includes a rigid and durable wire, or rod, which is formed into a substantially rectangular design, said wire defining the outer periphery of its associated frame. In addition, a mattress spring unit typically comprises a plurality of uniformly spaced apart metal springs, or coils, which extend between the upper and lower frames. Each spring includes a longitudinal axis which extends substantially at a right angle relative to the upper and lower frames. As can be appreciated, the plurality of springs enables the upper frame to move, or give, towards the lower frame when a downward force is applied onto the upper frame. As a result, when an individual rests on the upper frame of the spring unit, the body weight of said individual is uniformly absorbed by the plurality of springs, which is highly desirable.

It has been found that a user often routinely sits along one edge of a mattress (e.g., to remove his/her shoes). This frequent application of pressure along one edge of a mattress can cause the upper frame of the spring unit to warp substantially downward (i.e., bend or sag) along this edge. As can be appreciated, any substantial warping of the upper frame of a spring unit along one edge, in turn, causes the mattress to similarly sag along said edge, which is highly undesirable.

Accordingly, in order to protect its upper and lower frames, a mattress spring unit is often disposed within a foam encasement. Specifically, a foam encasement is a substantially rigid support structure which is shaped to define a substantially rectangular trough, or cavity. During construction of the mattress, the spring unit is sized and shaped to be fittingly disposed within the trough defined by the foam encasement. In this manner, the outer periphery of the mattress is defined by the foam encasement, which is substantially rigid and therefore highly unsusceptible to warping or bending, rather than the wire frames of the spring unit.

With the mattress spring unit snugly disposed within the foam encasement, many high-end mattresses often dispose multiple layers of varying density foam rubber on top of the spring unit and foam encasement. As can be appreciated, these layers of foam rubber serve to significantly increase the level of comfort of the mattress, which is highly desirable. Having disposed multiple layers of foam rubber onto the mattress spring unit and foam encasement, an outer layer of fabric (e.g., a quilted cotton material) is sewn over the spring unit, foam encasement and layers of foam rubber to form the finished mattress.

Referring now to FIGS. 1(a)-(d), there is shown one well-known technique for manufacturing a high-end mattress of the type as described above which includes a foam encasement for supporting a mattress spring unit. In the first step of the manufacturing process, a foam encasement 11 is constructed. As seen most clearly in FIG. 1(a), foam encasement 11 includes a plurality of individual foam blocks 13 (namely, a bottom block 13-1, a pair of side blocks 13-2 and 13-3, a front block 13-4 and a rear block 13-5). The individual foam blocks 13 are then secured together using an adhesive 15. Specifically, adhesive 15 is applied to at least some of the following contact surfaces: (1) the top surface of bottom foam block 13-1 along its outer periphery, (2) the inner surface of each of side foam blocks 13-2 and 13-3 proximate its ends, and (3) the ends of front and rear foam blocks 13-4 and 13-5. With adhesive 15 sprayed onto the above-identified contact surfaces, adjacent blocks 13 are first aligned and then drawn into contact with one another so as to form the unitary, five-sided foam encasement 11 shown in FIG. 1(b), said foam encasement 11 being sized and shaped to define a cavity 16.

Having constructed foam encasement 11, a mattress spring unit 17 is then deposited within cavity 16, as shown in FIG. 1(c). With spring unit 17 positioned within foam encasement 11, adhesive 15 is applied to the top contact surfaces of blocks 13-2, 13-3, 13-4 and 13-5 and then, in a subsequent step, one or more layers of foam rubber 19 are adhered to foam encasement 11 so as to effectively trap spring unit 17 within cavity 16, as shown in FIG. 1(d). In the final step of the mattress manufacturing process, an outer layer of fabric (not shown) is preferably sewn over foam encasement 11 and layers of foam rubber 19 to form the finished mattress.

It should be noted that the above-described method of using adhesives to secure together the individual blocks of a foam encasement suffers from a few notable drawbacks.

As a first drawback, the use of adhesives to secure together the individual blocks of a foam encasement results in a significant level of waste. Specifically, if the individual blocks are secured together in misalignment, there is no means to separate the blocks and attempt to re-secure the blocks in proper alignment. As a result, blocks of material which are secured together in misalignment are often discarded as waste, thereby increasing manufacturing costs, which is highly undesirable.

As a second drawback, the use of adhesives to secure together the individual blocks of a foam encasement creates an unhealthy amount of fumes in the working environment where the mattress is manufactured, thereby rendering its workers susceptible to potentially harmful conditions, which is highly undesirable.

As a third drawback, the use of adhesives to secure together the individual blocks of a foam encasement often creates audible crackling sounds within the mattress as the adhesives age, which is highly undesirable.

### SUMMARY OF THE INVENTION

It is an object of the present invention to provide a new and improved mattress and method of manufacturing the same.

It is another object of the present invention to provide a mattress comprising a foam encasement for protecting a mattress spring unit and a method for manufacturing the same.

It is yet another object of the present invention to provide a mattress as described above which includes a foam encasement constructed from a plurality of individual foam blocks.

It is still another object of the present invention to provide a mattress as described above which secures the individual foam blocks of a foam encasement without the use of adhesives.

It is yet still another object of the present invention to provide a mattress as described above which is simple in its construction and inexpensive to manufacture.

Therefore, according to one feature of the present invention, there is provided a mattress comprising (a) a spring unit, and (b) a foam encasement shaped to define an interior cavity which is sized and shaped to at least partially receive said spring unit, said foam encasement comprising, (i) a plurality of individual foam blocks, and (ii) one or more plastic fasteners for securing together said plurality of individual foam blocks.

According to another feature of the present invention, there is provided a method for manufacturing a mattress, said method comprising the steps of (a) forming a foam encasement by securing together a plurality of individual foam blocks using one or more plastic fasteners, said foam encasement being shaped to define an interior cavity, (b) providing a mattress spring unit, and (c) depositing the mattress spring unit within the interior cavity of the foam encasement.

Various other features and advantages will appear from the description to follow. In the description, reference is made to the accompanying drawings which form a part thereof, and in which is shown by way of illustration, various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIGS. 1(a)-(d) display selected components of a prior art mattress at various stages during its well-known manufacturing process;

FIG. 2 is a top perspective view of a mattress constructed according to the teachings of the present invention, the outer layer of quilted fabric being shown broken away in part in order to more adequately display the various components contained therewithin;

FIG. 3 is a top perspective view, broken away in part, of the mattress shown in FIG. 2, the mattress being shown without its outer layer of quilted fabric in order to more adequately display the various components contained therewithin;

FIG. 4 is a perspective view of the foam encasement shown in FIG. 3;

FIG. 5 is an exploded perspective view of the blocks for the foam encasement shown in FIG. 4;

FIG. 6 is an enlarged, front plan view of one of the fasteners shown in FIG. 4;

FIG. 7 is an enlarged, fragmentary section view of the foam encasement shown in FIG. 4 taken along lines 7-7, the fastener not being shown in section for purposes of clarity.

FIG. 8 is an enlarged, front plan view of a fastener that could be used in the foam encasement of the present invention in place of the fastener shown in FIG. 6;

FIG. 9(a) is a front perspective view of another fastener that could be used in the foam encasement of the present invention in place of the fastener shown in FIG. 6;

FIG. 9(b) is a right end perspective view of the fastener shown in FIG. 9(a);

FIG. 9(c) is a front plan view of the fastener shown in FIG. 9(a);

FIG. 9(d) is a top plan view of the fastener shown in FIG. 9(a);

FIG. 9(e) is a section view of the fastener shown in FIG. 9(d) taken along lines 9(e)-9(e);

FIG. 9(f) is an enlarged, fragmentary front perspective view of the fastener shown in FIG. 9(a);

FIG. 10 is a front perspective view of the fastener shown in FIG. 9(a), said fastener being shown in conjunction with a complementary fastener insertion tool which is constructed according to the teachings of the present invention;

FIG. 11 is an enlarged, section view of a pair of a foam blocks being held together using the fastener shown in FIG. 9(a), the fastener being shown in perspective form for purposes of clarity only, the fastener being shown driven into said pair of foam blocks using the fastener insertion tool shown in FIG. 10; and

FIGS. 12(a)-(e) display selected components of a mattress constructed according to the teachings of the present invention at various stages during its novel manufacturing process, selected components of the mattress being shown secured together using fasteners of the type shown in FIG. 9(a).

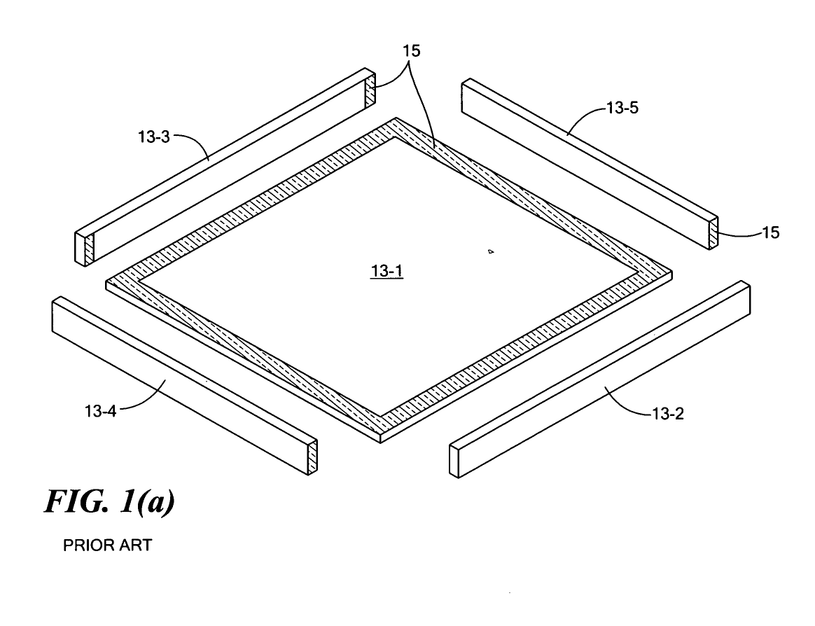

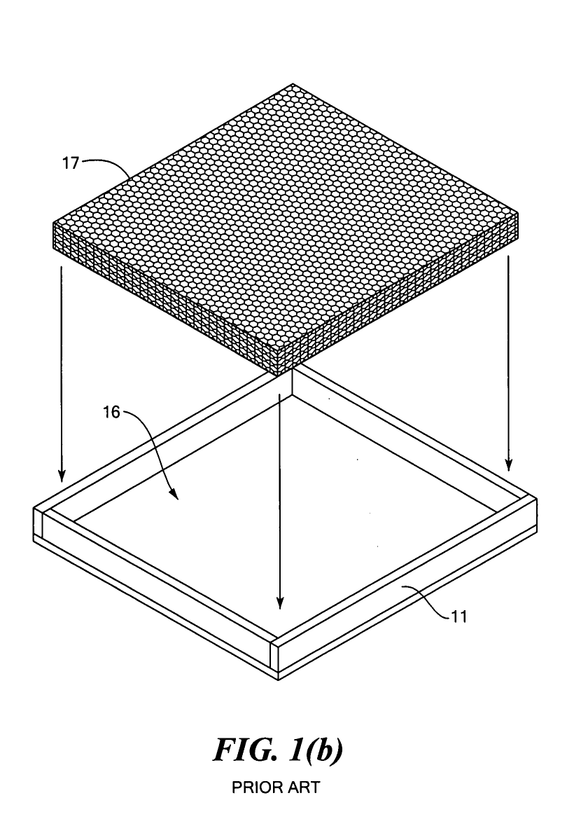

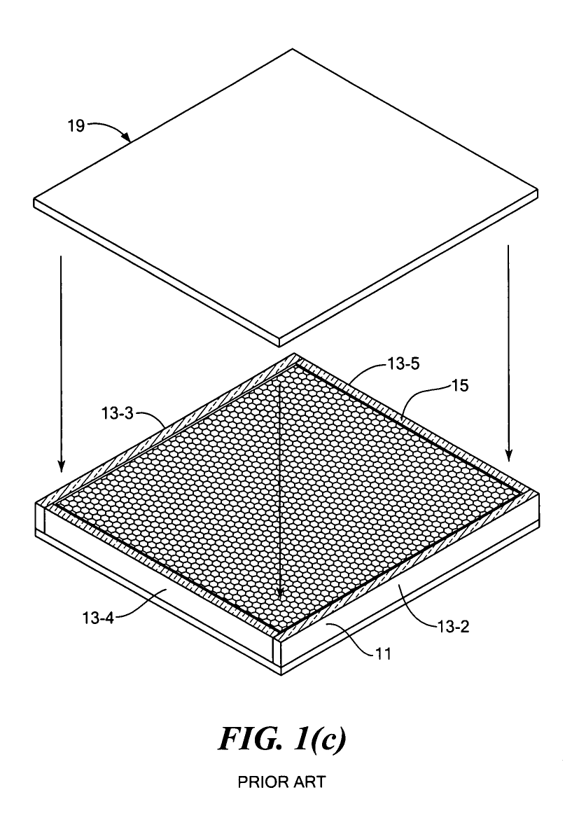

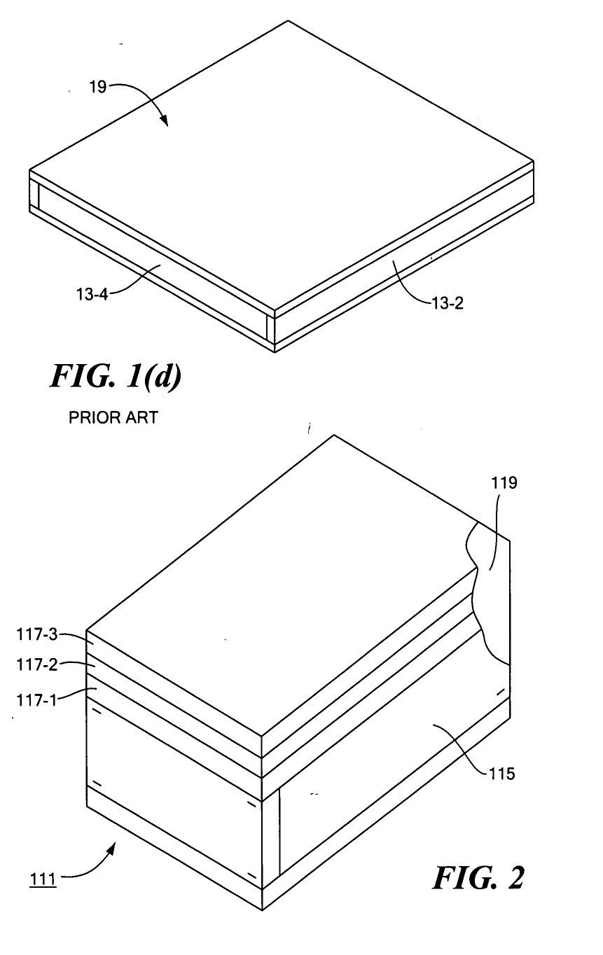

### DETAILED DESCRIPTION OF THE PREFERRED EMBODIMENT

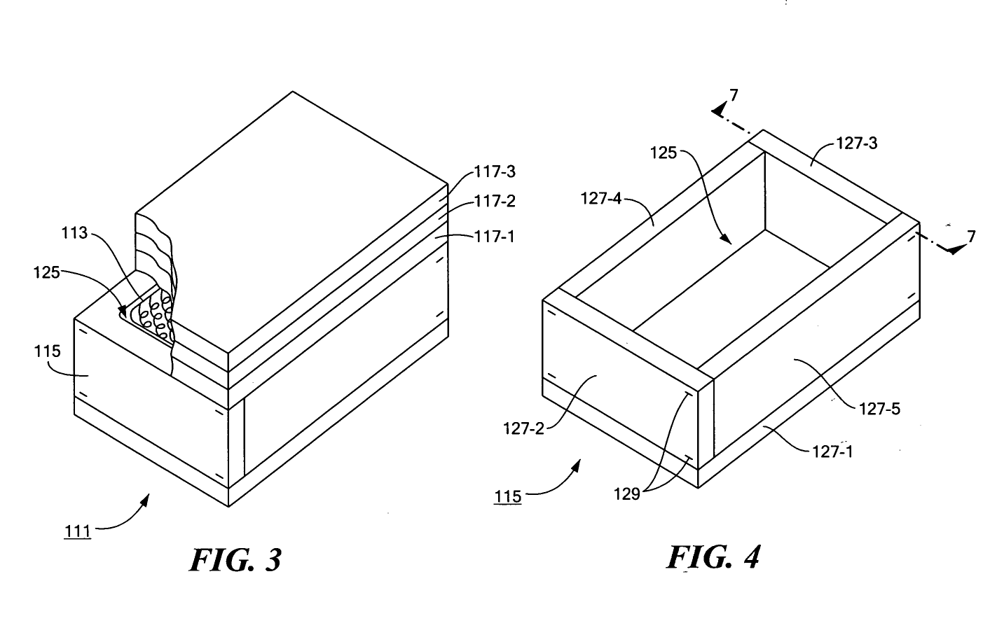

Referring now to FIGS. 2 and 3, there is shown a mattress constructed according to the teachings of the present invention, said mattress being identified generally by reference numeral 111.

Mattress 111 comprises a conventional mattress spring unit 113, a foam encasement 115 in which spring unit 113 is disposed, a plurality of foam rubber layers 117-1, 117-2 and 117-3 disposed on top of spring unit 113 and foam encasement 115, and an outer layer of fabric 119, such as a quilted cotton material, that is sewn over spring unit 113, foam encasement 115 and layers of foam rubber 117 to render mattress 111 a unitary item.

Mattress spring unit 113 preferably includes identical upper and lower metal frames which are spaced slightly apart and which are arranged in a substantially parallel configuration. Each metal frame (also referred to herein as a wire box) includes a rigid and durable wire, or rod, which is formed into a substantially rectangular design, wherein said wire defines the outer periphery of its associated metal frame.

Mattress spring unit 113 additionally includes a plurality of uniformly spaced apart metal springs, or coils, which extend between the upper and lower metal frames. Each spring includes a longitudinal axis which extends substantially at a right angle relative to the upper and lower metal frames. As can be appreciated, the plurality of springs enable the upper frame to move, or give, towards the lower frame when a downward force is applied onto said upper frame. As a result, when an individual rests on the upper metal frame, the body weight of said individual is uniformly absorbed by the plurality of springs, which is highly desirable.

It should be noted that the particular construction of mattress spring unit 113 does not serve as a novel feature of the present invention. In fact, the construction of mattress spring unit 113 is well-known in the art. Accordingly, it is to be understood that mattress spring unit 113 could be replaced with any other type of conventional mattress spring unit without departing from the spirit of the present invention.

Foam encasement 115 is shaped to define a trough, or cavity, 125 which is sized and shaped to snugly receive spring unit 113, as seen most clearly in FIG. 3. In this manner, foam encasement 115 serves to protect the wire for each metal frame in mattress spring unit 113 from warping or otherwise bending when someone repeatedly rests along one edge of mattress 111.

As seen most clearly in FIGS. 4 and 5, foam encasement 115 includes a plurality of individual blocks 127, each block 127 being constructed out of a porous foam material. Specifically, foam encasement 115 is constructed using five separate rectangular foam blocks 127 (namely, a bottom block 127-1, a front block 127-2, a rear block 127-3, a first side block 127-4 and a second side block 127-5). Together, blocks 127 define trough 125.

Adjacent foam blocks 127 are secured together using a plurality of individual plastic fasteners 129, as can be seen in FIG. 4. It should be noted that the use of plastic fasteners 129 to secure together the individual foam blocks 127 of foam encasement 115 serves as the principal novel feature of the present invention. It is to be understood that the present invention is not limited to a particular number or spacing of fasteners 129 to secure together foam blocks 127. Rather, the number and relative spacing of fasteners 129 used to join foam blocks 127 could be modified, as deemed necessary, without departing from the spirit of the present invention.

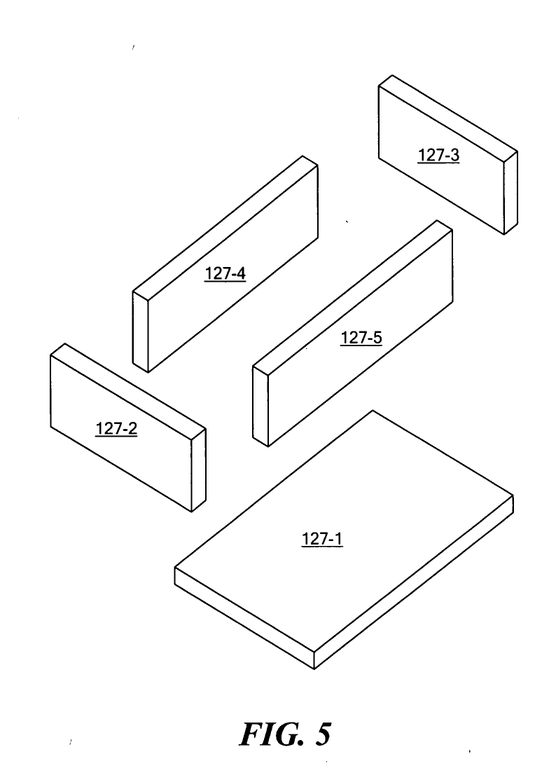

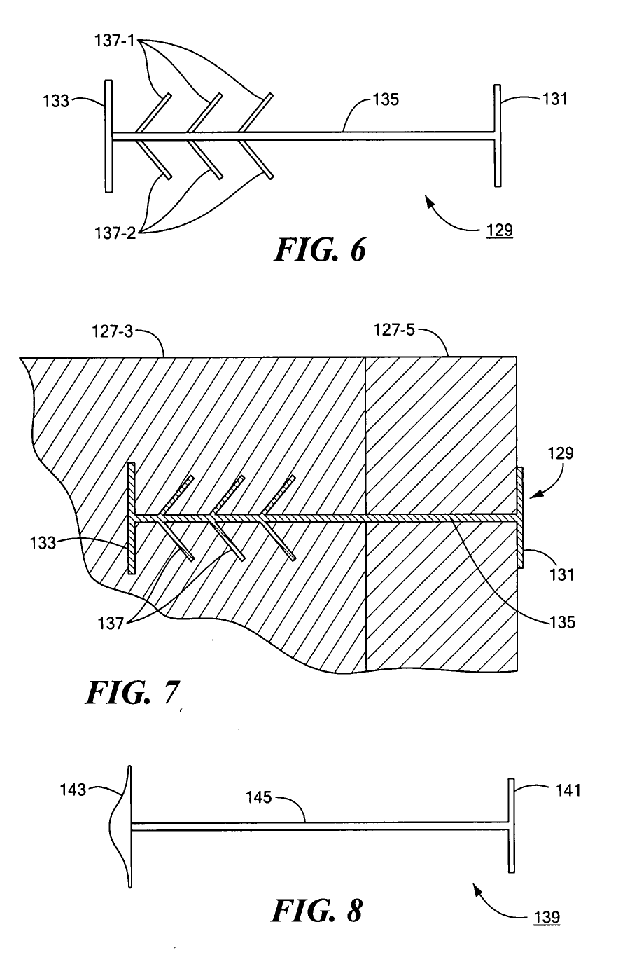

Referring now to FIG. 6, there is shown an enlarged front plan view of a single fastener 129. Fastener 129 is a heavy duty plastic fastener which includes a first end shaped to define a cross-bar 131 (also commonly referred to as a “T-bar”), a second end similarly shaped to define a cross-bar 133 (also commonly referred to as a “T-bar”), and a thin filament 135 interconnecting cross-bars 131 and 133. In addition, fastener 129 includes three pairs of fingers 137 which are integrally formed onto filament 135, each pair of fingers 137 extending from filament 135 in a V-shaped orientation. Specifically, a first set of parallel fingers 137-1 extend out from one side of filament 135 at an acute angle relative thereto and a second set of parallel fingers 137-2 extend out from the opposite side of filament 135 at an acute angle relative thereto. In this manner, fastener 129 is provided with a fishbone-type design.

It should be noted that plastic fastener 131 may be mass-produced in a unitary form known commonly as fastener stock. The fastener stock could be constructed in a clip-type assembly in which individual plastic fasteners 129 are arranged in a spaced, side-by-side orientation, with the respective cross-bars 131 and 133 parallel to one another, each of cross-bars 131 being joined to a common, orthogonally-disposed runner bar by a severable connector. The aforementioned fastener clip would preferably be manufactured through the process of injection molding.

As noted above, fasteners 129 are used to secure together adjacent foam blocks 127. Preferably, fasteners 129 are driven through adjacent foam blocks 127 using an automated fastener dispensing tool of the type described in U.S. patent Ser. No. 10/865,684, which was filed on Jun. 6, 2004 in the names of William G. Berrocal et al., the disclosure of which is incorporated herein by reference. Fasteners are driven through adjacent blocks 127 such that second end 133 and fingers 137 are embedded within one of said blocks 127 and such that first end 131 is disposed flush against the exterior surface of the other of said blocks 127.

Specifically, referring now to FIG. 7, there is shown an enlarged section view of foam encasement 115. As can be seen, with blocks 127-3 and 127-5 held together in their proper orientation relative to one another, second end 133 of fastener 129 is driven through block 127-5 and embeds itself within block 127-3, with first end 131 remaining outside and disposed flush against block 127-5. In this manner, fastener 129 serves to maintain blocks 127-3 and 127-5 affixed together in the proper relationship relative to one another. Further, it is to be understood that fingers 137 similarly embed themselves within block 127-3 and serve as means for anchoring fastener 129 in place within blocks 127-3 and 127-5, which is highly desirable.

Referring back to FIGS. 2 and 3, with spring unit 113 disposed snugly within the trough 125 defined by foam encasement 115, multiple layers of varying density foam rubber 117 are mounted over spring unit 113 and foam encasement 115 in proper alignment therewith. Specifically, a first layer of foam rubber 117-1 is mounted onto foam encasement 115 over spring unit 113 in proper alignment therewith, a second layer of foam rubber 117-2 is mounted onto first layer of foam rubber 117-1 in proper alignment therewith, and a third layer of foam rubber 117-3 is mounted onto second layer of foam rubber 117-2 in proper alignment therewith.

With layers of foam rubber 117 disposed over spring unit 113 and foam encasement 115 in the manner described above, one or more plastic fasteners (e.g., fasteners 29) may be used to retain the various layers of mattress 111 in position with respect to one another. In addition, an outer layer of fabric 119, such as a quilted cotton material, is preferably sewn over (i.e., encases) spring unit 113, foam encasement 115 and layers of foam rubber 117 to render mattress 111 a unitary item.

It should be noted that additional layers may be inserted into mattress 111 without departing from the spirit of the present invention. For example, a pillow top may be inserted into mattress 111 for additional support and comfort.

It should also be noted that layers may be removed from mattress 111 without departing from the spirit of the present invention. For example, one or more foam layers 117-1, 117-2 and 117-3 could be removed from mattress 111 without departing from the spirit of the present invention.

It should further be noted that, for simplicity purposes only, foam blocks 127 of encasement 115 are shown herein as being secured together using fasteners 129. However, it is to be understood that foam encasement 115 is not limited to the use of one particular type of plastic fastener (e.g., fastener 129). Rather, it should be known that alternative types of plastic fasteners could be used in place of fastener 129 without departing from the spirit of the present invention.

As an example, referring now to FIG. 8, there is shown another type of plastic fastener which could be used to secure together the various blocks 25 of foam encasement 115 in place of fastener 129 without departing from the spirit of the present invention, said plastic fastener being identified generally by reference numeral 139.

Fastener 139 represents a heavy duty plastic fastener which is well-known in the art. Specifically, plastic fastener 139 is in the form of an H-shaped heavy duty fastener of the type sold by Avery Dennison Corporation as part of the Extra Heavy Duty T-end™ system. Specifically, plastic fastener 139 is preferably in the form of a 3 inch plastic member which includes a first end shaped to define a cross-bar 141 (also commonly referred to as a “T-bar”), a second end similarly shaped to define a cross-bar 143 (also commonly referred to as a “T-bar”), and a thin filament 145 interconnecting cross-bars 141 and 143.

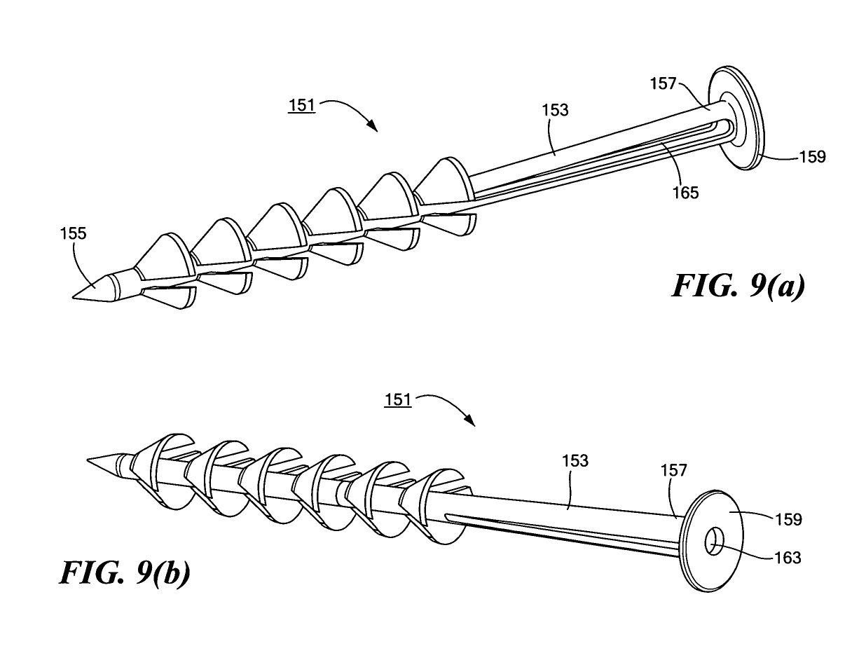

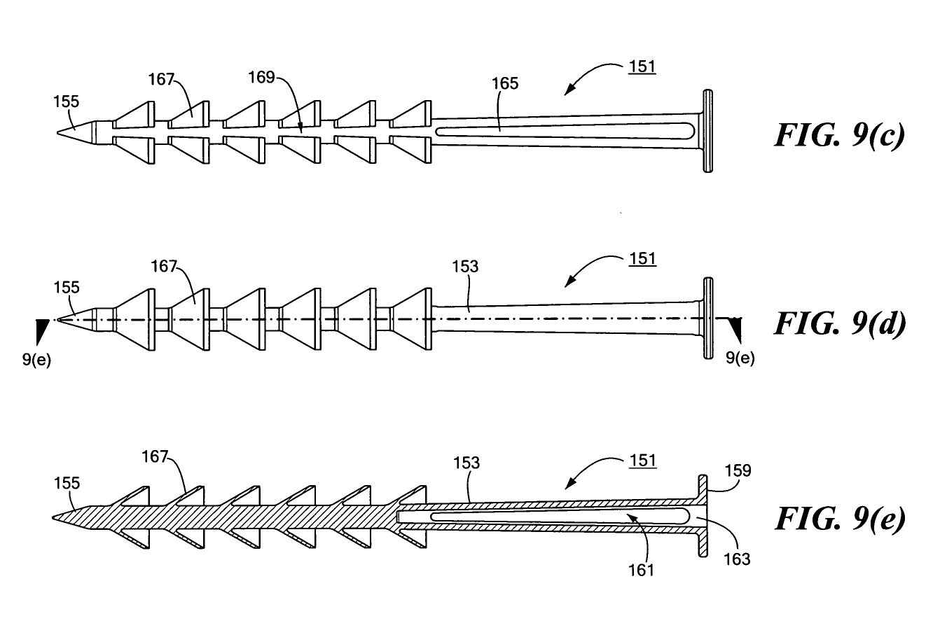

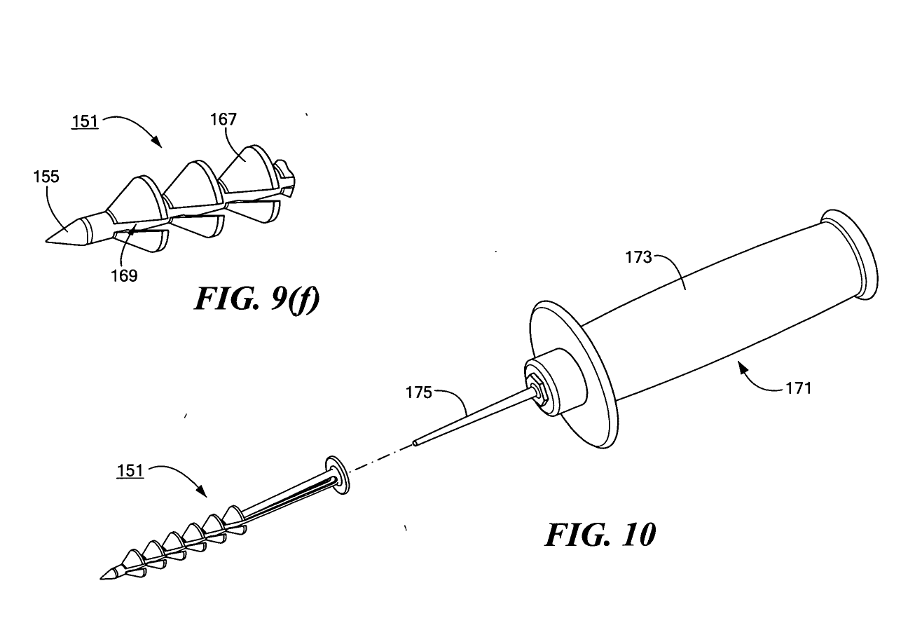

As another example, referring now to FIGS. 9(a)-(f), there are shown various views of another type of plastic fastener which could be used to secure together the various blocks 125 of foam encasement 115 in place of fastener 129 without departing from the spirit of the present invention, said plastic fastener being identified generally by reference numeral 151.

Plastic fastener 151 is a unitary member that includes an elongated stem 153 having a first end 155 and a second end 157.

First end 155 of stem 153 is formed in the shape of a sharpened tip, as seen most clearly in FIG. 9(f). As can be appreciated, the sharpened tip design of first end 155 reduces the force required to insert fastener 151 through one or more layers of foam, which is highly desirable.

A disc-shaped head 159 is integrally formed onto second end 157 of stem 153, as seen most clearly in FIG. 9(b). As can be appreciated, head 159 functions as a stop for limiting the degree of insertion of fastener 151 through one or more layers of foam, as will be described further below.

Stem 153 is hollowed out along a portion of its length proximate second end 157 so as to define an elongated, longitudinal interior channel 161, as seen most clearly in FIG. 9(e). Channel 161 is preferably circular in lateral cross-section and is externally accessible through a circular opening 163 formed in head 159. As will be described further below, channel 161 serves as a means by which an associated tool may insert fastener 151 through one or more layers of foam.

A pair of longitudinal slots, or splits, 165 are provided in stem 153 along a portion of its length proximate second end 157. Slots 165 enable stem 153 of fastener 151 to compress, or give, upon the application of a considerable compressive force. As a result, stem 153 is able to suitably buckle if a considerable load is applied on either of its ends, which is highly desirable.

A plurality of equidistantly spaced fir-tree type flutes 167 is formed along the length of stem 153 proximate sharpened tip 155. Each flute 167 is somewhat conical in shape and extends at an acute angle away from stem 153 in the direction towards head 159. As will be described further below, together flutes 167 serve to engage the foam blocks of the encasement so as to render its extraction therefrom particularly difficult. The large undercut formed by each flute 167 as a result of its inherent design (as seen most clearly in FIG. 9(e)) serves to increase the extraction force required to withdraw fastener 151 from one or more foam layers.

It should be noted that fastener 151 is represented herein as including six flutes 167. However, it is to be understood that the number of flutes 167 provided for fastener 151 could be modified without departing from the spirit of the present invention. For example, in order to increase the extraction force associated with fastener 151, additional flutes 167 could be provided along stem 153.

As seen most clearly in FIG. 9(f), one or more splits 169 are formed into each flute 167. Splits 169 enable each flute 167 to inwardly compress, thereby reducing the insertion force associated with fastener 151. It should be noted that splits 169 are additionally provided so as to allow fastener 151 to be manufactured using conventional injection molding techniques.

Referring now to FIG. 10, there is shown a hand-held tool for use in conjunction with the insertion of fastener 151 through one or more foam blocks 127, said hand-held tool being constructed according to the teachings of the present invention and identified generally by reference numeral 171. As can be seen, tool 171 includes an enlarged handle 173 and a tapered rod 175 which extends co-axially away from one end of handle 173.

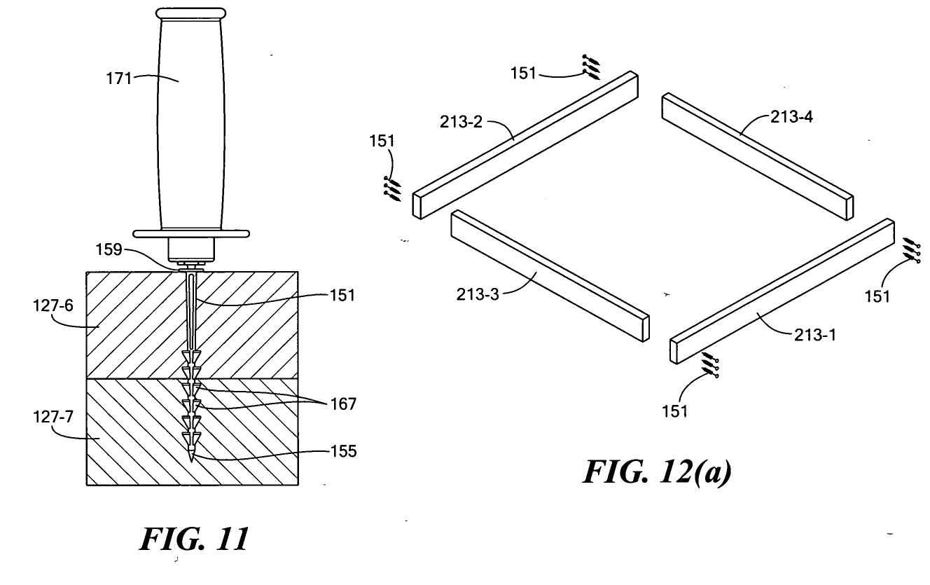

In use, tool 171 can be used in the following manner to insert fastener 151 through one or more foam blocks 127. Specifically, tapered rod 175 of tool 171 is directed through opening 163 in head 159 and is inserted into channel 161 in co-axial alignment therewith. As seen most clearly in FIG. 11, with fastener 151 mounted on rod 175 of tool 171 in the manner described above, the user grasps handle 171 and urges sharpened tip 155 of fastener 151 through foam blocks 127-6 and 127-7 until head 159 abuts against the outer surface of block 127-6 so as to limit further insertion. With fastener 151 inserted in this manner, flutes 167 suitably engage blocks 127-6 and 127-7 so as to render extraction considerably difficult. At this point, tool 171 can be easily withdrawn from fastener 151, thereby leaving fastener 151 in its proper position extending transversely through blocks 127-6 and 127-7.

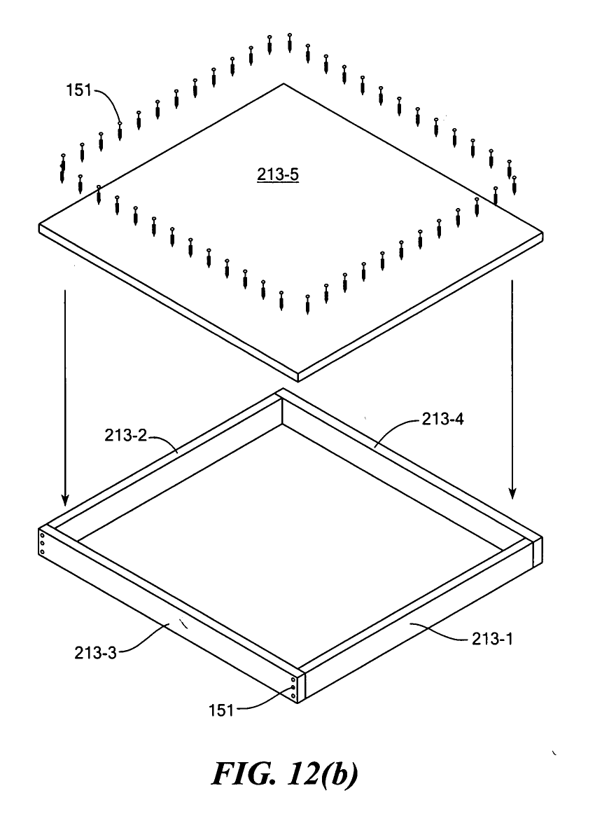

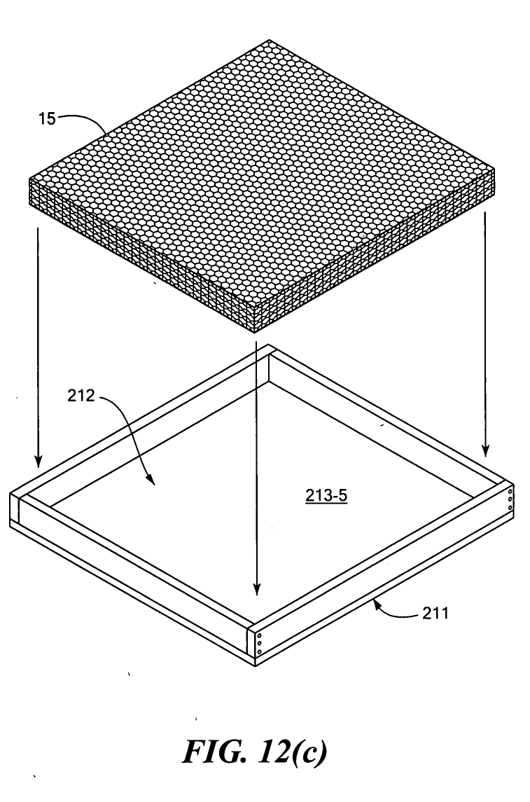

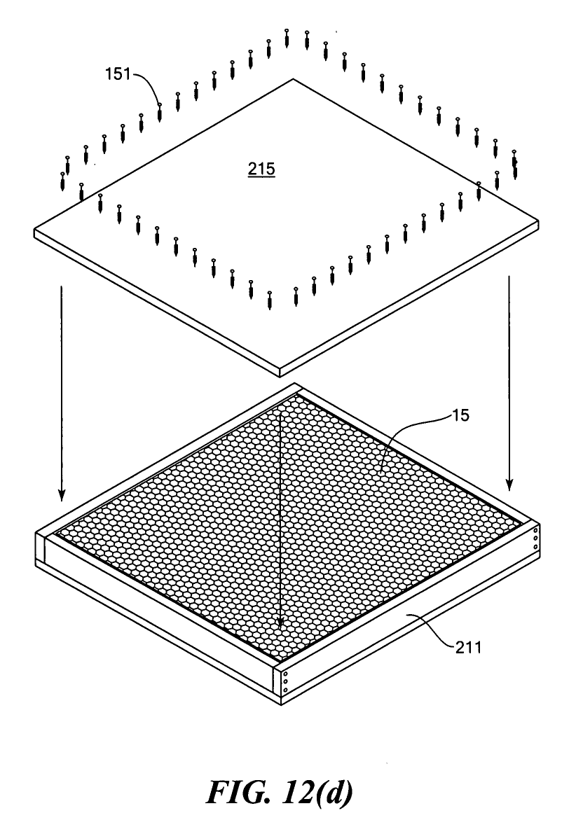

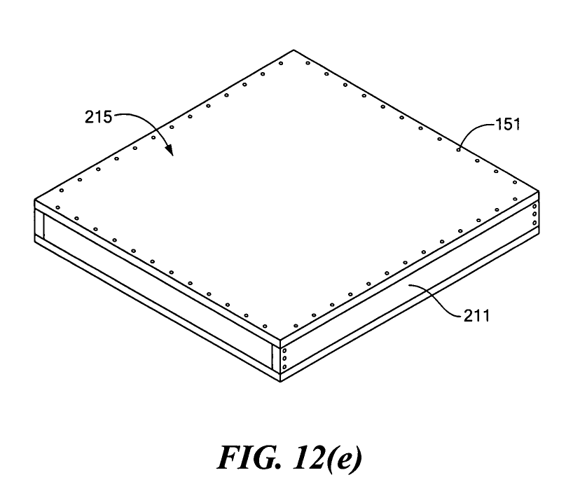

Referring now to FIGS. 12(a)-(d), there is shown a mattress constructed according to the teachings of the present invention at various stages during its novel manufacturing process, wherein selected components of the mattress (and in particular, a foam encasement 211 for said mattress) are shown secured together using fasteners 151. In the first step of the novel mattress manufacturing process, a plurality of fasteners 151 are used to secure side foam blocks 213-1 and 213-2 to opposing ends of front and rear foam blocks 213-3 and 213-4, as shown in FIG. 12(a). Unless otherwise stated, it is to be understood that fasteners 151 may be driven through foam blocks 213 using fastener insertion tool 171. As seen most clearly in FIG. 12(b), a flat panel-shaped block 213-5 is then disposed on top of the frame created by securing foam blocks 213-1 through 213-4 together and, in turn, is secured thereto by driving a plurality of fasteners 151 through block 213-5 and into each of blocks 213-1 through 213-4.

With bottom block 213-5 secured, the resulting product is flipped upside down so as to yield the five-sided foam encasement 211 of the present invention, said encasement 211 being shaped to define a central cavity 212, as shown in FIG. 12(c). To complete manufacture of the mattress, spring unit 15 is deposited within cavity 212, as shown in FIG. 12(d). With spring unit 15 positioned within foam encasement 211, at least one additional foam layer 215 is disposed on top of foam encasement 211 and, in a subsequent step, is secured thereto using one or more fasteners 151 so as to effectively trap spring unit 15 within cavity 212, as shown in FIG. 12(e). Having secured foam layers 215 to foam encasement 211, an outer layer of fabric (not shown) is preferably sewn therearound to produce the unitary finished mattress.

It is to be understood that, although the above-described mattress manufacturing process is shown using fasteners 151, alternative types of fasteners (e.g., fasteners 129 and/or 139) could be used in place thereof without departing from the spirit of the present invention.

It is also to be understood that a plurality of fasteners 151 (or similarly a plurality of fasteners 129 and 139) could be formed as a unitary clip without departing from the spirit of the present invention. In this manner, individual fasteners 151 could be readily dispensed from said clip using an automated fastener dispensing tool.

The embodiments shown of the present invention are intended to be merely exemplary and those skilled in the art shall be able to make numerous variations and modifications to them without departing from the spirit of the present invention. All such variations and modifications are intended to be within the scope of the present invention as defined in the appended claims.

1. A mattress comprising:
(a) a spring unit, and
(b) a foam encasement shaped to define an interior cavity which is sized and shaped to at least partially receive said spring unit, said foam encasement comprising,
(i) a plurality of individual foam blocks, and
(ii) one or more plastic fasteners for securing together said plurality of individual foam blocks.

2. The mattress of claim 1 wherein said foam encasement comprises a bottom block, a front block, a rear block and a pair of side blocks which are secured together using the one or more plastic fasteners.

3. The mattress as claimed in claim 1 wherein each of said one or more plastic fasteners comprises,
(a) a thin filament which includes a first end and a second end,
(b) a first cross-bar formed onto the first end of said thin filament, and
(c) a second cross-bar formed onto the second end of said thin filament.

4. The mattress as claimed in claim 3 wherein each of said one or more plastic fasteners additionally comprises at least one anchoring finger formed onto said thin filament at a location between its first and second ends.

5. The mattress as claimed in claim 4 wherein said at least one anchoring finger extends away from said thin filament at an acute angle relative thereto.

6. The mattress as claimed in claim 1 wherein each of said one or more plastic fasteners comprises,
(a) an elongated stem having a first end and a second end, and
(b) an enlarged head formed onto the second end of said elongated stem.

7. The mattress as claimed in claim 6 wherein the first end of said elongated stem is in the form of a sharpened tip.

8. The mattress as claimed in claim 6 wherein the elongated stem is hollowed out along at least a portion of its length so as to define a longitudinal interior channel.

9. The mattress as claimed in claim 8 wherein the longitudinal interior channel is externally accessible through an opening formed in the enlarged head.

10. The mattress as claimed in claim 6 further comprising a plurality of retention flutes formed along at least a portion of the length of the elongated stem.

11. A method of manufacturing a mattress, said method comprising the steps of:
(a) forming a foam encasement by securing together a plurality of individual foam blocks using one or more plastic fasteners, said foam encasement being shaped to define an interior cavity,
(b) providing a mattress spring unit, and
(c) depositing the mattress spring unit within the interior cavity of the foam encasement.

12. The method of claim 11 wherein the foam encasement formed includes a bottom block, a front block, a rear block and a pair of side blocks which are secured together by said one or more plastic fasteners.

13. The method of claim 12 further comprising the step of, after said depositing step, disposing one or more foam layers on top of said foam encasement.

14. The method of claim 13 further comprising the step of, after said disposing step, securing said one or more foam layers to the foam encasement using one or more plastic fasteners.

15. A plastic fastener comprising:
(a) a thin filament which includes a first end and a second end,
(b) a first bar disposed at the first end of the thin filament,
(c) a second bar disposed at the second end of said thin filament, and
(d) a first anchoring finger formed onto the thin filament at a location between its first and second ends.

16. The mattress as claimed in claim 15 wherein the first anchoring finger extends away from the thin filament at an acute angle relative thereto.

17. The plastic fastener as claimed in claim 16 wherein the first bar is disposed at the first end of the thin filament at a right angle relative thereto.

18. The plastic fastener as claimed in claim 17 wherein the second bar is disposed at the second end of the thin filament at a right angle relative thereto.

19. The plastic fastener as claimed in claim 16 further comprising a second anchoring finger formed onto the thin filament at a location between its first and second ends, the second anchoring finger extending away from thin filament at an acute angle relative thereto.

20. The plastic fastener as claimed in claim 19 wherein the first and second anchoring fingers are together disposed in a generally V-shaped configuration.
